(19) United States
(12) Patent Application Publication
(10) Pub. No.: US 2026/0109194 A1
(43) Pub. Date: Apr. 23, 2026

(54) OFF-ROAD VEHICLE

(71) Applicant: KAWASAKI MOTORS, LTD., Akashi-shi (JP)

(72) Inventors: Tatsuya HATANAKA, Akashi-shi (JP); Takashi HISAMURA, Akashi-shi (JP)

(73) Assignee: KAWASAKI MOTORS, LTD., Akashi-shi (JP)

(21) Appl. No.: 19/363,184

(22) Filed: Oct. 20, 2025

(30) Foreign Application Priority Data
Oct. 22, 2024 (JP) 2024-185925

(51) Int. Cl. B60G 21/02; B60G 3/20; B60G 15/02; B60N 2/015; B60T 17/00

(52) U.S. Cl. CPC B60G 21/026; B60G 3/20; B60G 15/02; B60N 2/015; B60T 17/00; B60G 2200/144; B60G 2202/135; B60G 2204/1224; B60G 2300/07

(57) ABSTRACT

A utility vehicle includes: a body frame; left and right arms rotatably coupled to the body frame; a stabilizer bar supported by the body frame and extending above the left and right arms; and link rods that couple both ends of the stabilizer bar to the left and right arms. The stabilizer bar includes a bar body extending in vehicle width directions, and arm parts individually extending from both ends of the bar body toward one side in front-rear directions and coupled to the link rods. The arm parts extend upward toward the one side.

### CROSS-REFERENCE TO RELATED APPLICATION

This application claims priority to Japanese Patent Application No. 2024-185925 filed on Oct. 22, 2024, the disclosure of which including the specification, the drawings, and the claims is hereby incorporated by reference in its entirety.

### FIELD

The technique disclosed here relates to an off-road vehicle.

### BACKGROUND

U.S. Patent Application Publication No. 2019/0299736 discloses a vehicle including arms, a stabilizer bar, and a shock absorber. The arms are rotatably coupled to a body frame and individually located at the left and right of the body frame. The stabilizer bar is supported by the body frame and attached to the left and right arms. The shock absorber couples the body frame to the arms.

### SUMMARY

An off-road vehicle disclosed here includes: a body frame; left and right arms rotatably coupled to the body frame; stabilizer bar supported by the body frame and extending above the left and right arms; and link rods that couple both ends of the stabilizer bar to the left and right arms, wherein the stabilizer bar includes a bar body extending in vehicle width directions, and arm parts individually extending from both ends of the bar body toward one side in front-rear directions and coupled to the link rods, and the arm parts extend upward toward the one side.

An off-road vehicle disclosed here includes: a body frame; and left and right arms rotatably coupled to the body frame; and a coilover located inward of each of the arms in vehicle width directions, wherein each of the arms includes an arm body in which a cable is located, and a side wall attached to the arm body and located between the cable and the coilover.

### BRIEF DESCRIPTION OF THE DRAWINGS

FIG. 1 is a left side view of a utility vehicle.

FIG. 2 is a rear view of the utility vehicle.

FIG. 3 is a perspective view illustrating a rear portion of a body frame, a suspension link, and a stabilizer bar.

FIG. 4 is an enlarged perspective view illustrating a portion of FIG. 3.

FIG. 5 is a left side view illustrating the rear portion of the body frame, the suspension link, and the stabilizer bar.

FIG. 6 is an enlarged left side view of an arm part of the stabilizer bar in FIG. 5.

FIG. 7 is a plan view illustrating the rear portion of the body frame, the suspension link, and the stabilizer bar.

FIG. 8 is a perspective view of a rear portion of an arm, a coilover, and a cover, when seen from the left rear.

FIG. 9 is a perspective view of the rear portion of the arm, the coilover, and the cover, when seen from the left side.

FIG. 10 is a perspective view of the rear portion of the arm and the coilover, when seen from the left side.

FIG. 11 is a cross-sectional view of the rear portion of the arm, the coilover, and the cover, when seen from the left front.

### DESCRIPTION OF EMBODIMENTS

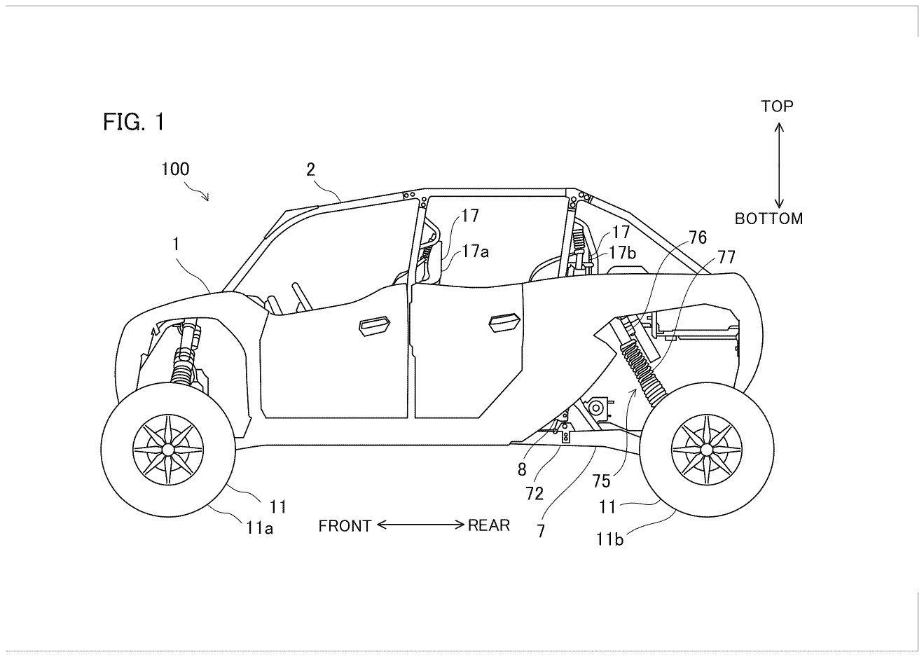

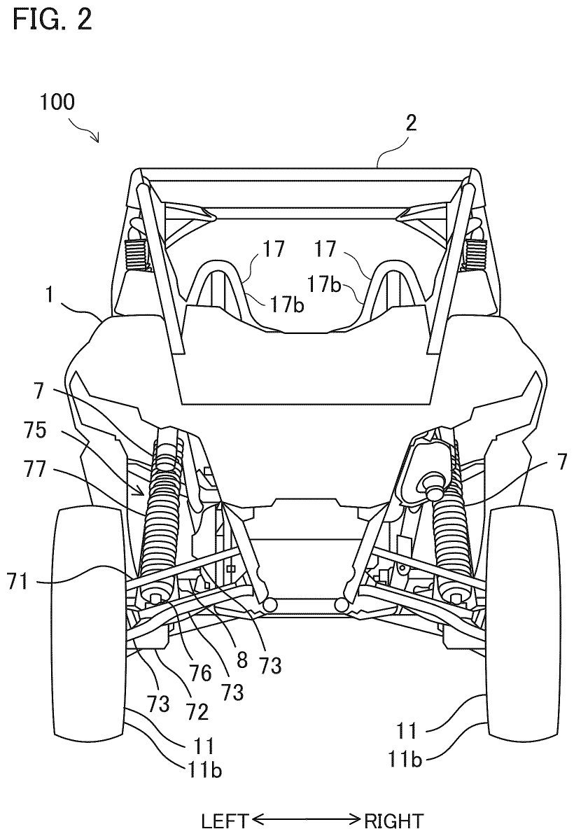

An exemplary embodiment will be described in detail hereinafter with reference to the drawings. FIG. 1 is a left side view of a utility vehicle 100. FIG. 2 is a rear view of the utility vehicle 100. The utility vehicle 100 can travel off-road. The utility vehicle 100 is an example of an off-road vehicle. Hereinafter, the utility vehicle 100 will also be referred to simply as a “vehicle 100.”In this disclosure, components of the vehicle 100 will be described based on directions of the vehicle 100. Specifically, “front” refers to the front in the front-rear directions of the vehicle 100, and “rear” refers to the rear in the front-rear directions of the vehicle 100. Further, “left” refers to the left of the vehicle 100 when seeing forward, and “right” refers to the right of the vehicle 100 when seeing forward. The “vehicle width directions” refer to the vehicle width directions of the vehicle 100, in other words, refers to the left-right directions of the vehicle 100 and will be sometimes referred to as “left-right directions.” An “inner side or inward in the vehicle width directions” refers to a cabin side in the vehicle width directions, and an “outer side or outward in the vehicle width directions” refers to a vehicle outer side in the vehicle width directions.

The vehicle 100 includes a body 1, a body frame 2, wheels 11, seats 17 on which passengers are seated, suspensions 7 that reduce impact and vibration transmitted from the wheels 11 to the body frame 2, and a stabilizer bar 8 that reduces roll of the vehicle 100.

The wheels 11 include left and right front wheels 11a and left and right rear wheels 11b. That is, the vehicle 100 is a four-wheeled vehicle. When the front wheels 11a and the rear wheels 11b are not distinguished from each other, these wheels are simply referred to as “wheels 11.”

The seats 17 include front seats 17a and rear seats 17b located rearward of the front seats 17a. In this example, the seats 17 include two front seats 17a disposed in the left-right directions, and two rear seats 17b disposed in the left-right directions. When the front seats 17a and the rear seats 17b are not distinguished from each other, these seats are referred to simply as “seats 17.”

The suspensions 7 are rear suspensions that suspend the rear wheels 11b. The suspensions 7 are located at the left and right of the body frame 2. The stabilizer bar 8 is a rear stabilizer bar that couples the left and right suspensions 7 to each other.

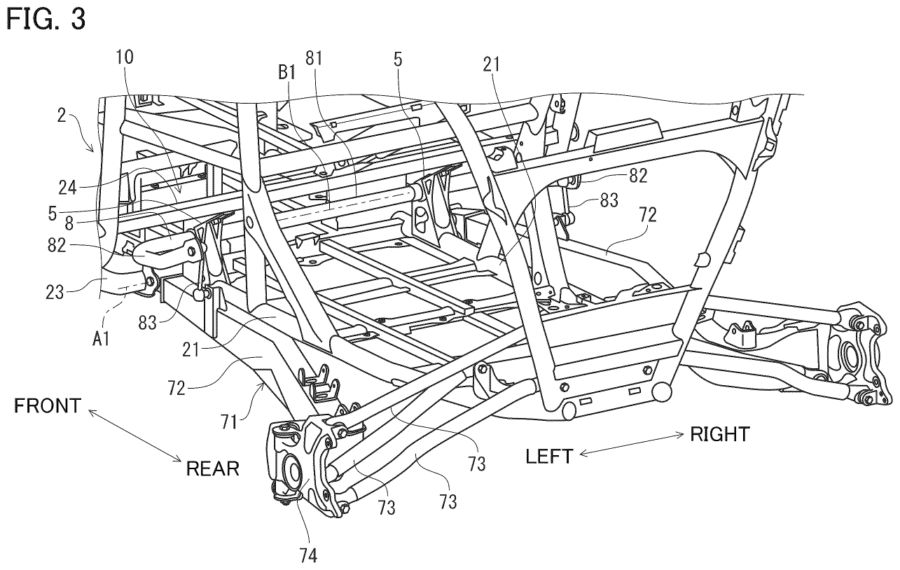

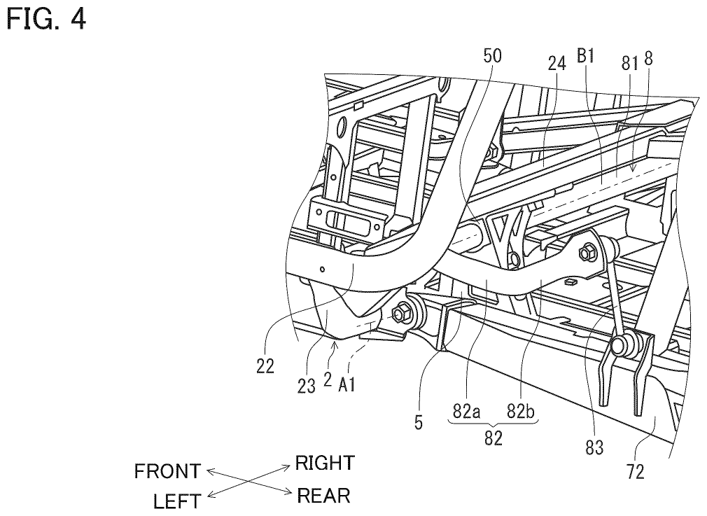

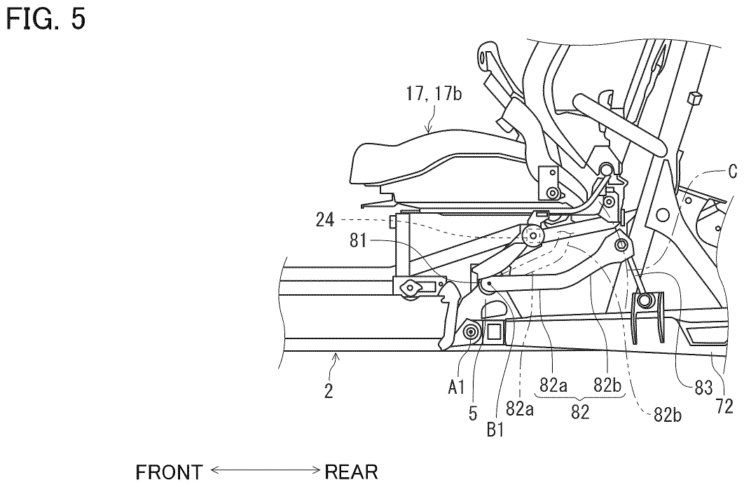

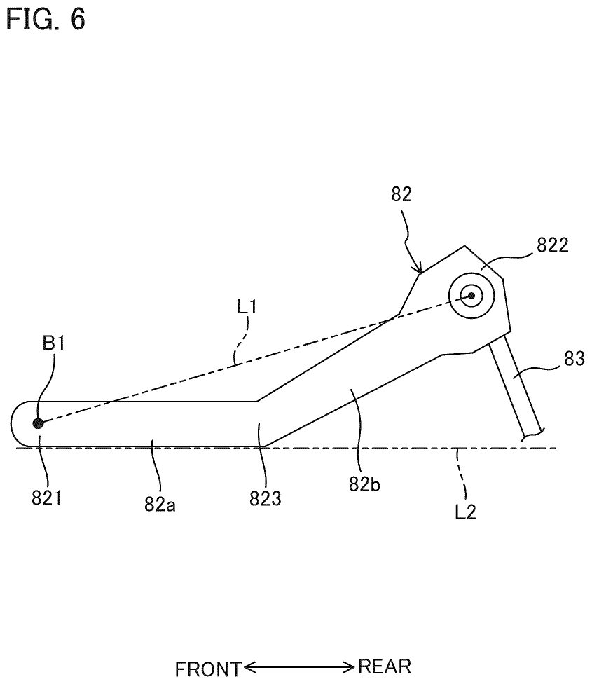

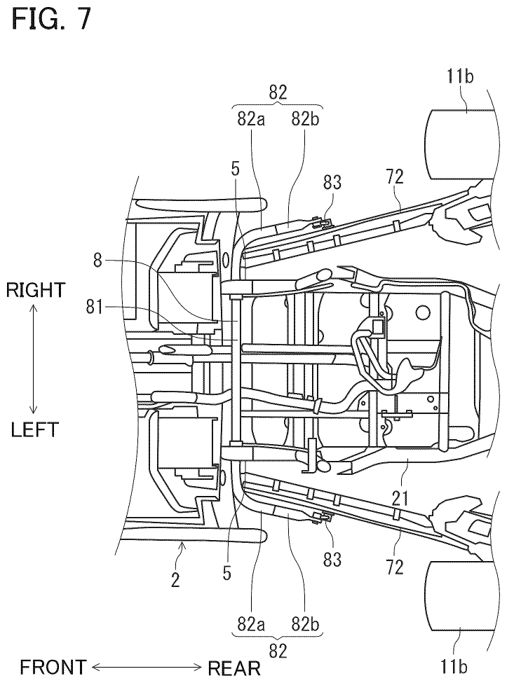

FIG. 3 is a perspective view illustrating a rear portion of the body frame 2, a suspension link 71, and the stabilizer bar 8. FIG. 4 is an enlarged perspective view illustrating a portion of FIG. 3. FIG. 5 is a left side view illustrating a rear portion of the body frame 2, the suspension link 71, and the stabilizer bar 8. FIG. 6 is an enlarged left side view of an arm part 82 of the stabilizer bar 8 in FIG. 5. FIG. 7 is a plan view illustrating a rear portion of the body frame 2, the suspension link 71, and the stabilizer bar 8.

The body frame 2 includes a beam frame 24 supporting the seats 17, and support frames 5 supporting the beam frame 24. The body frame 2 further includes left and right main frames 21, left and right side frames 22, and coupling frames 23 coupling the main frames 21 and the corresponding side frames 22. Each frame of the body frame 2 is formed of, for example, a metal pipe.

The main frames 21 extend substantially in the front-rear directions in a space below the seats 17. The left and right main frames 21 are disposed side by side with a space therebetween in the left-right directions. The left and right side frames 22 are located outward of the left and right main frames 21 in the vehicle width directions. The side frames 22 extend substantially in the front-rear directions. The coupling frames 23 extend substantially in the vehicle width directions and couple the main frames 21 to the corresponding side frames 22. The main frames 21, the side frames 22, and the coupling frames 23 are frames mainly constituting a framework of the vehicle 100.

The support frames 5 are individually located to the left and right main frames 21. The left and right support frames 5 are located substantially at the same position in the front-rear directions. The support frames 5 are formed of, for example, metal plates. The support frames 5 are fixed to the main frames 21 by, for example, welding. The support frames 5 extend upward from the main frames 21.

The beam frame 24 extends in the vehicle width directions in a space above the main frames 21. The beam frame 24 is, for example, a metal pipe. The beam frame 24 is located below the seats 17, specifically, the rear seats 17b. The rear seats 17b are attached to the beam frame 24 from above. The beam frame 24 is attached to the left and right support frames 5. Specifically, the beam frame 24 is fixed to the support frames 5 by, for example, welding.

The suspensions 7 are independent suspensions. That is, the left and right suspensions 7 support the left and right rear wheels 11b independently of each other. Each of the suspensions 7 includes the suspension link 71 supporting the corresponding rear wheel 11b such that the rear wheel 11b is movable upward and downward, and a coilover 75 located between the body frame 2 and the rear wheel 11b (see FIG. 1).

The suspension link 71 includes an arm 72 defining the position of the rear wheel 11b in the front-rear directions, and control rods 73 defining the position of the rear wheel 11b in the left-right directions. The arm 72 and the control rods 73 support a knuckle 74. The rear wheel 11b is rotatably attached to the knuckle 74.

The arm 72 is located at each of the left and right. The arm 72 is a trailing arm in this example, but may be a double wishbone arm. The arm 72 extends substantially in the front-rear directions. The front end portion of the arm 72 is rotatably coupled to the body frame 2. The knuckle 74 is coupled to the rear end portion of the arm 72. Specifically, the arm 72 is coupled to the coupling frame 23 to be rotatable about a rotation axis A1 extending in the vehicle width directions. The arm 72 can swing about the rotation axis A1 to cause the knuckle 74 to move substantially upward and downward. The rotation axis A1 is located forward of the beam frame 24.

The control rods 73 extend outward from the body frame 2 in the vehicle width directions. In this example, each suspension link 71 includes three control rods 73. An end portion of each of the control rods 73 is coupled to the body frame 2 to be rotatable about a rotation axis extending substantially in the front-rear directions. The other end portion of each control rod 73 is coupled to the knuckle 74 to be rotatable about the rotation axis extending substantially in the front-rear directions. The control rods 73 can swing with respect to the body frame 2 to cause the knuckle 74 to move substantially upward and downward. In this manner, the knuckle 74 is supported by the suspension link 71 to be movable substantially in the top-bottom directions.

Each coilover 75 is located inward of the arm 72 in the vehicle width directions. The coilover 75 couples the body frame 2 and the arm 72 to each other.

The coilover 75 includes a shock absorber 76, and a spring 77 located to the shock absorber 76 (see FIG. 2). The shock absorber 76 is, for example, an air cylinder or a hydraulic cylinder. The shock absorber 76 coupes the body frame 2 and the arm 72 to each other. The spring 77 is a coil spring located around the shock absorber 76. The spring 77 elastically couples the body frame 2 and the arm 72.

Sine the knuckles 74 are supported by the suspension links 71 to be movable upward and downward, when the rear wheels 11b receive impact from the road surface, the rear wheels 11b move upward and downward relative to the body frame 2. At this time, the shock absorbers 76 and the springs 77 absorb the impact. Accordingly, vibrations of the body frame 2 are reduced.

The stabilizer bar 8 is supported by the body frame 2 and extends above the left and right arms 72. Both ends of the stabilizer bar 8 are individually coupled to the left and right arms 72 through link rods 83. Accordingly, the left and right arms 72 are coupled to each other through the stabilizer bar 8. The stabilizer bar 8 deforms to be twisted in conjunction with movement of the left and right arms 72.

The stabilizer bar 8 is made of, for example, a metal. The stabilizer bar 8 includes a bar body 81 extending in the vehicle width directions, and arm parts 82 individually extending rearward from both ends of the bar body 81 and coupled to the link rods 83. The term “rearward” toward which the arm parts 82 extend is an example of “one side in the front-rear directions”herein.

The bar body 81 is located above the left and right main frames 21 and below the beam frame 24. The bar body 81 is supported by the body frame 2 to be rotatable about an axis B1 of the bar body 81.

Specifically, the bar body 81 is supported by the left and right support frames 5. The bar body 81 is supported by the support frames 5 to be rotatable about the axis B1. More specifically, the bar body 81 penetrates the support frames 5 in the vehicle width directions. That is, the bar body 81 is inserted in through holes of the support frames 5. Elastically deformable bushes 50 are located between the outer peripheral surface of the bar body 81 and the inner peripheral surfaces of the through holes of the support frames 5. The bar body 81 slides relative to the bushes 50. That is, the bar body 81 is rotatable about the axis B1 thereof.

The arm parts 82 are coupled to the arms 72 through the link rods 83. Specifically, the left arm part 82 is coupled to the left arm 72 through the link rod 83. The right arm part 82 is coupled to the right arm 72 through the link rod 83. Ball joints, for example, are used in coupling portions between the link rods 83 and the arm parts 82 and coupling portions between the link rods 83 and the arms 72.

When a difference in the vertical position occurs between the left and right rear wheels 11b during, for example, turning of the vehicle 100, a difference in the swing angle occurs between the left and right arms 72 with respect to the body frame 2. When a difference in swing angle occurs between the left and right arms 72, torsion deformation of the bar body 81 of the stabilizer bar 8 occurs. The stabilizer bar 8 reduces the difference in the swing angle between the left and right arms 72 by an elastic force by the torsion deformation. This reduces roll of the vehicle 100.

As illustrated in FIG. 5 in particular, the arm parts 82 extend upward toward the rear. Specifically, each of the arm parts 82 includes a linear first portion 82a and a linear second portion 82b. The first portion 82a extends rearward from the bar body 81. The front end of the first portion 82a is connected to an end portion of the bar body 81 in the vehicle width directions. The second portion 82b extends rearward from the first portion 82a. The front end of the second portion 82b is connected to the rear end of the first portion 82a. The rear end of the second portion 82b is coupled to the link rod 83.

The first portion 82a is tilted less than the second portion 82b. Specifically, the tilt angle of the axis of the first portion 82a with respect to the horizontal directions is smaller than the tilt angle of the axis of the second portion 82b with respect to the horizontal directions. Specifically, the tilt angle refers to a tilt with respect to the ground while no load is applied to the vehicle body, that is, while no load in the top-bottom directions is applied to the arms 72.

The second portion 82b is located rearward of the beam frame 24 above the arm part 82. The beam frame 24 is an example of a “structure located above the arm part 82” herein. The second portion 82b does not overlap the beam frame 24 in the top-bottom directions. The first portion 82a overlaps the beam frame 24 in the top-bottom directions.

The axis B1 of the bar body 81 is located below the seats 17. The axis B1 overlaps the seats 17 in the top-bottom directions. The axis B1 is located below the beam frame 24. The axis B1 is located forward of the beam frame 24.

The distance between the axis B1 of the bar body 81 and the rotation axis A1 of each arm 72 is shorter than the length of each link rod 83. The distance between the axis B1 and the rotation axis A1 is a minimum distance between the axis B1 and the rotation axis A1. The axis B1 is located above the rotation axis A1. The axis B1 is located rearward of the rotation axis A1.

As illustrated in FIG. 6 in particular, an intermediate portion 823 of each of the arm parts 82 is separated from an imaginary line L1 connecting both end portions 821 and 822 of the arm part 82 in the vehicle width directions. The both end portions 821 and 822 of the arm part 82 includes a first end portion 821 and a second end portion 822. The first end portion 821 is connected to the bar body 81. The second end portion 822 is coupled to the link rod 83. The imaginary line L1 intersects a portion overlapping an axis B1 of the first end portion 821 and a coupling portion (specifically a coupling shaft) of the second end portion 822 to the link rod 83, when seen in the vehicle width directions. Specifically, the intermediate portion 823 is located below the imaginary line L1 when seen in the vehicle width directions. The intermediate portion 823 is a connection portion between the first portion 82a and the second portion 82b.

As illustrated in FIG. 6 in particular, the second end portion 822 of the arm part 82 is separated from an imaginary tangent L2 that is in contact with the lower end of the first end portion 821 of the arm part 82 and extends rearward, when seen in the vehicle width directions. The imaginary tangent L2 is in contact with the lowermost end of the first end portion 821. Specifically, the second end portion 822 is located above the imaginary tangent L2 when seen in the vehicle width directions.

As illustrated in FIG. 7 in particular, the arm parts 82 extend along the arms 72 in a plan view. Specifically, each of the arms 72 extends outward in the vehicle width directions toward the rear in a plan view. The arm parts 82 extend outward in the vehicle width directions toward the rear in a plan view. In other words, the distance between the left and right arms 72 in the vehicle width directions increases toward the rear in a plan view. The distance between the left and right arms portions 82 in the vehicle width directions increases toward the rear in a plan view.

As illustrated in FIG. 7 in particular, the arm parts 82 are located outward of the arms 72 in the vehicle width directions. Specifically, the right arm part 82 is located outward of the right arm 72 in the vehicle width directions in a plan view. The left arm part 82 is located outward of the left arm 72 in the vehicle width directions in a plan view.

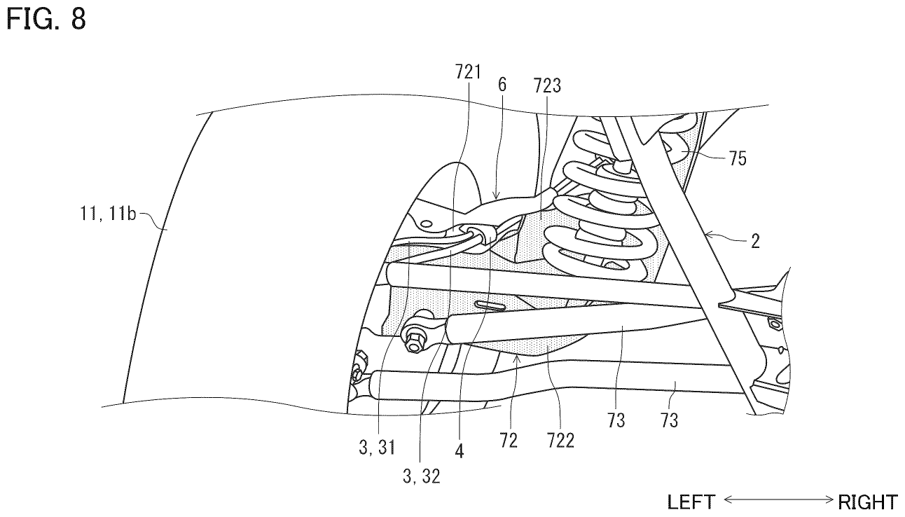

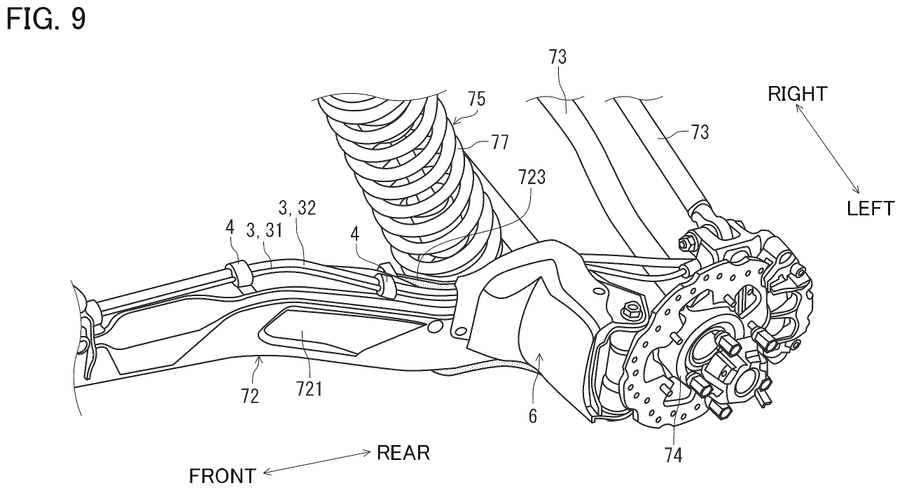

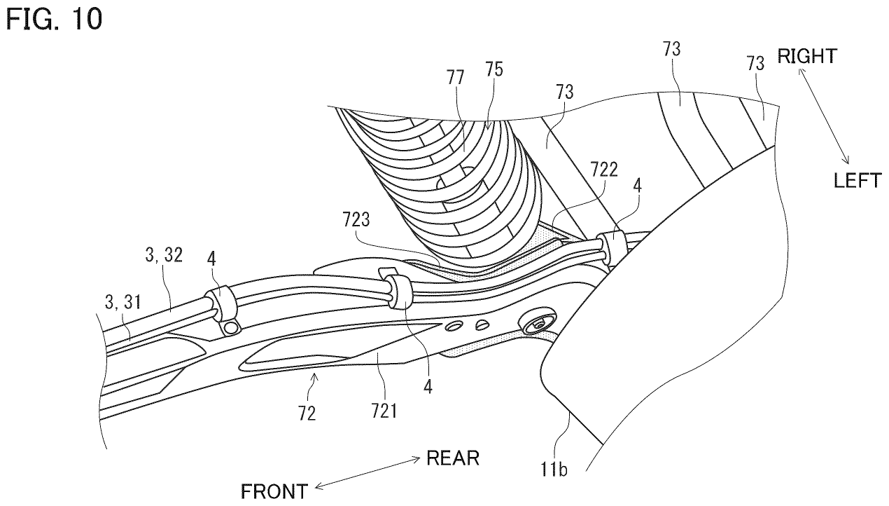

FIG. 8 is a perspective view of a rear portion of the arm 72, the coilover 75, and a cover 6, when seen from the left rear. FIG. 9 is a perspective view of a rear portion of the arm 72, the coilover 75, and the cover 6, when seen from the left side. FIG. 9 does not show the rear wheel 11b. FIG. 10 is a perspective view of the rear portion of the arm 72 and the coilover 75, when seen from the left side. FIG. 10 does not show the cover 6.

The arm 72 includes an arm body 721 and a cover part 722. The arm body 721 extends in the front-rear directions. Cables 3 are located in the arm body 721. Specifically, the cables 3 are located along the upper surface of the arm body 721. The cables 3 are fixed to the arm body 721 through clamps 4. The clamps 4 are arranged at intervals in the front-rear directions.

The cables 3 include a first cable 31 and a second cable 32. The first cable 31 is a brake hose. The brake hose is a hose that transmits a hydraulic pressure of a brake fluid. The second cable 32 is a parking cable. The parking cable is a cable related to parking braking that fixes to prevent the wheels 11 from moving while the vehicle 100 is parked. When the first cable 31 and the second cable 32 are not distinguished from each other, these cables are simply referred to as “cables 3.”

The cover part 722 is attached to the inner side of the arm body 721 in the vehicle width directions. The cover part 722 is illustrated with dots in FIGS. 8 through 10 for convenience. The cover part 722 includes a side wall 723. That is, the side wall 723 is attached to the arm body 721. The side wall 723 is located between the cables 3 and the coilover 75. Specifically, the side wall 723 is located on the inner side of the cables 3 in the vehicle width directions, and on the outer side of the coilover 75 in the vehicle width directions. The side wall 723 covers the cables 3 from the inner side in the vehicle width directions.

The side wall 723 projects upward from the upper surface of the arm body 721. The height of the side wall 723 is higher than the height of the cables 3. The height of the side wall 723 is substantially equal to the height of the clamps 4. The height of the side wall 723 is not limited to the height described above.

The side wall 723 is located along a portion of the periphery of the coilover 75. Specifically, the side wall 723 is located in a portion of the arm body 721 facing the periphery of the coilover 75. This portion of the arm body 721 has a shape extending substantially along the periphery of the coilover 75.

The vehicle 100 further includes the cover 6. The cover 6 covers the cable 3 from above and from the outer side in the vehicle width directions. The cover 6 is attached to the arm 72. The cover 6 is an arm cover. The arm cover faces the inner peripheral surface of the wheel 11 (rear wheel 11b in this example), and uniformizes a gap between the inner peripheral surface of the wheel 11 and the arm cover. Accordingly, even when foreign substance such as a stone enters the gap while the wheel 11 is rotating, this foreign substance can be discharged from the gap without clogging in the gap. A material for the arm cover is, for example, thermoplastic olefinic elastomer (TPO)) or polypropylene (PP).

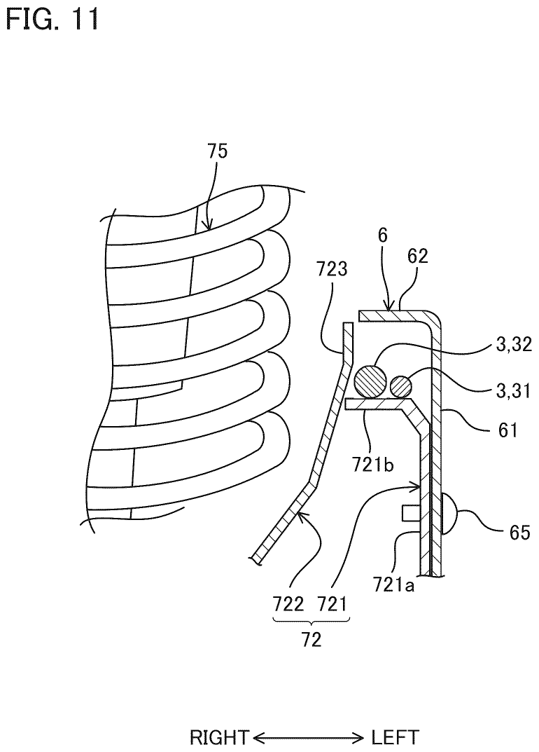

FIG. 11 is a cross-sectional view of a rear portion of the arm 72, the coilover 75, and the cover 6, when seen from the left front. The cover 6 serves as a tunnel structure through which the cables 3 passes, together with the side wall 723.

Specifically, the arm body 721 includes a vertical wall 721a extending in the top-bottom directions, and an upper wall 721b extending from the upper end of the vertical wall 721a toward the inner side in the vehicle width directions. The cables 3 are located on the upper surface of the upper wall 721b.

The cover 6 includes a vertical wall 61 extending in the top-bottom directions, and an upper wall 62 extending from the upper end of the vertical wall 61 toward the inner side in the vehicle width directions. The vertical wall 61 is located on the outer side of the vertical wall 721a in the vehicle width directions. The vertical wall 61 is in contact with the vertical wall 721a. The vertical wall 61 is attached to the vertical wall 721a through a screw 65. The upper wall 62 is located above the upper wall 721b. The upper wall 62 is separated from the upper wall 721b.

The side wall 723 is located on the inner side of the upper wall 721b in the vehicle width directions. The side wall 723 projects upward from the upper surface of the upper wall 721b. The upper end of the side wall 723 is located close to the inner end of the upper wall 62 in the vehicle width directions.

The side wall 723, the upper wall 721b, the vertical wall 61, and the upper wall 62 define a space. This space serves as the tunnel structure. The cables 3 are placed in this space. The side wall 723 covers the cables 3 from the inner side in the vehicle width directions. The vertical wall 61 covers the cables 3 from the outer side in the vehicle width directions. The upper wall 62 covers the cables 3 from above.

In the vehicle 100 described above, since the arm parts 82 extend upward toward the rear, the rear ends of the arm parts 82 are separated from the arms 72, and the length of the link rods 83 can be increased. Accordingly, when the link rods 83 swing following upward swing of the arms 72, the swing angle of the link rods 83 can be reduced. The swing angle of the link rods 83 is a tilt angle of the link rods 83 after swing with respect to the link rods 83 before swing. For example, the swing angle of the link rods 83 is an angle defined by the axis of the link rods 83 before swing and the axis of the link rods 83 after swing, when seen in the vehicle width directions. Accordingly, it is possible to reduce a load applied to coupling portions between the link rods 83 and the arm parts 82 and coupling portions between the link rods 83 and the arms 72. For example, in the case of using a ball joint in a coupling portion, the ball joint has a limited swing angle but the link rod 83 has a swing angle, and thus, a load applied to the ball joint can be reduced.

Specifically, if the length of the link rods 83 is short, when the link rods 83 swing following upward swing of the arms 72, the swing angle of the link rods 83 increases. Accordingly, a load applied to coupling portions between the link rods 83 and the arm parts 82 and coupling portions between the link rods 83 and the arms 72 increases. In this disclosure, since the arm parts 82 extend upward toward the rear, the length of the link rod 83 is long. Accordingly, the swing angle of the link rods 83 decreases, and a load applied to the coupling portions between the link rods 83 and the arm parts 82 and the coupling portions between the link rods 83 and the arms 72 is reduced.

In addition, since the first portion 82a is tilted less than the second portion 82b, in a case where the body frame 2 includes the beam frame 24 located above the first portion 82a and extending in the vehicle width directions, even when the arm parts 82 swing upward following upward swing of the arms 72, contact between the arm parts 82 and the beam frame 24 can be avoided.

In addition, since the second portion 82b is located rearward of the beam frame 24, even when the arm parts 82 swing upward following upward swing of the arms 72, contact between the arm parts 82 and the beam frame 24 can be avoided. Specifically, as indicated by the chain double-dashed lines in FIG. 5, even when the first portion 82a and the second portion 82b swing upward around the axis B1, the second portion 82b is located rearward of the beam frame 24 and can avoid contact with the beam frame 24.

Further, since the intermediate portion 823 of each arm part 82 is separated from the imaginary line L1 when seen in the vehicle width directions, the arm part 82 is not in a straight line. Accordingly, as compared to a case where each arm part 82 is in a straight line, the arm part 82 can be easily positioned to prevent interference with a surrounding structure. In addition, the overall length of the arm parts 82 can be increased to enhance strength of the arm parts 82.

Furthermore, since the intermediate portion 823 of each arm part 82 is located below the imaginary line L1 when seen in the vehicle width directions, in a case where the beam frame 24 is located above the arm part 82, even when the arm part 82 swings upward following upward swing of the arm 72, contact between the arm part 82 and the beam frame 24 can be avoided.

Since the second end portion 822 of each arm part 82 is separated from the imaginary tangent L2 when seen in the vehicle width directions, the arm part 82 is not in a straight line. Accordingly, as compared to a case where the arm part 82 is in a straight line, the arm part 82 can be easily positioned to prevent interference with a surrounding structure. In addition, the overall length of the arm parts 82 can be increased to enhance strength of the arm parts 82.

Since the second end portion 822 of each arm part 82 is located above the imaginary line L2 when seen in the vehicle width directions, in a case where the beam frame 24 is located above the arm part 82, even when the arm part 82 swings upward following upward swing of the arm 72, contact between the arm part 82 and the beam frame 24 can be avoided.

Since each arm part 82 extends along the arm 72 in a plan view, when the link rod 83 swings following upward swing of the arm 72, movement of the arm part 82 can be matched with movement of the arm 72. Specifically, the arm part 82 can be moved substantially in parallel with the arm 72, and the swing angle of the link rods 83 can be reduced. Accordingly, the swing angle of the link rod 83 can be reduced. Since the arm part 82 extends along the arm 72 in a plan view, the link rod 83 can be oriented substantially in parallel with the arm part 82 and the arm 72 in a plan view. This reduces the attachment angle of the link rods 83 to the arm parts 82 and the arms 72 with respect to the direction in which the arm parts 82 and the arms 72 extend in a plan view.

Since the arm parts 82 extend outward in the vehicle width directions toward the rear in a plan view, in a case where the arms 72 extend outward in the vehicle width directions toward the rear in a plan view, the arm parts 82 extend along the arms 72. Accordingly, when the link rods 83 swing following upward swing of the arms 72, movement of the arm part 82 can be matched with movement of the arm 72. Specifically, the arm part 82 can be moved substantially in parallel with the arm 72, and the swing angle of the link rods 83 can be reduced. This can reduce the swing angle of the link rod 83. In this case, the link rod 83 can be oriented substantially in parallel with the arm part 82 and the arm 72 in a plan view, and the attachment angle of the link rods 83 to the arm parts 82 and the arms 72 with respect to the direction in which the arm parts 82 and the arms 72 extend can be reduced in a plan view.

Since the axis B1 of the bar body 81 is located below the seats 17, the axis B1 of the bar body 81 can be made close to the coupling portion between the arm 72 and the body frame 2, specifically, the rotation axis A1 of the arm 72. Accordingly, the angle formed by the stabilizer bar 8 and the link rods 83 can be made close to 90°, and when the arms 72 swing upward, the link rods 83 transfer an upward force applied to the arms 72 to the arm parts 82 without releasing the force in other directions. This can reduce a load applied to the link rods 83. In other words, each link rod 83 can be coupled to the stabilizer bar 8 such that the link rod 83 extends in the tangential direction of a circle C (indicated by the chain line in FIG. 5) that is centered on the axis B1 of the bar body 81 and passes through the coupling portion between the link rod 83 and the stabilizer bar 8. Accordingly, the link rod 83 transfers an upward force applied to the arm 72 to the stabilizer bar 8 in the tangential direction of the circle C, that is, in the rotation direction about the axis B1 of the bar body 81.

The distance between the axis B1 of the bar body 81 and the rotation axis A1 of each arm 72 is shorter than the length of the link rods 83, and thus, the axis B1 of the bar body 81 can be made close to the rotation axis A1 of the arms 72. Accordingly, the angle formed by the stabilizer bar 8 and the link rods 83 can be made close to 90°, and when the arms 72 swing upward, the link rods 83 transfer an upward force applied to the arms 72 to the arm parts 82 without releasing the force in other directions. This can reduce a load applied to the link rods 83.

Since the arm parts 82 are located outward of the arms 72 in the vehicle width directions, interference of the arm parts 82 with the arms 72 can be reduced.

Since each arm 72 includes the side wall 723 between the cables 3 and the coilover 75, the side wall 723 can prevent interference between the cables 3 and the coilover 75.

Since the cables 3a are brake hoses, the side wall 723 can prevent interference between the brake hoses and the coilover 75.

Since the side wall 723 is located along a portion of the periphery of the coilover 75, the side wall 723 can prevent interference between the cables 3 and the coilover 75.

Since the cover 6 covers the cables 3 from above and from the outer side in the vehicle width directions, the cover 6 can protect the cables 3 against stones and other substance that are thrown up from the wheels during traveling of the vehicle.

Since the cover 6 serves as the tunnel structure together with the side wall 723, the cover 6 covers the periphery of the cables 3.

Since the cover 6 is an arm cover, the arm cover also protects the cables 3.

### First Variation

Next, a vehicle 100 (an example of an off-road vehicle) according to a first variation will be described with reference mainly to FIGS. 8 through 11. Unlike the vehicle 100 according to the embodiment, in the vehicle 100 according to the first variation, the shape of the arm parts 82 of the stabilizer bar 8 is not limited. That is, the arm parts 82 do not need to extend upward toward the rear. For example, the arm parts 82 may extend downward toward the rear or may extend linearly in the horizontal directions. Alternatively, the arm parts 82 may extend upward toward the rear. In the first variation, the same reference characters as those in the embodiment denote the same components, and thus, description thereof will be omitted.

The vehicle 100 according to the first variation includes a body frame 2, left and right arms 72 rotatably coupled to the body frame 2, and a coilover 75 located inward of each of the arms 72 in the vehicle width directions. Each of the arms 72 includes an arm body 721 in which cables 3 are located, and a side wall 723 attached to the arm body 721 and located between the cables 3 and the coilover 75.

The cables 3 are brake hoses. The side wall 723 is located along a portion of the periphery of the coilover 75.

The vehicle 100 further includes a cover 6 covering the cables 3 from above and from the outer side in the vehicle width directions. The cover 6 serves as a tunnel structure through which the cables 3 passes, together with the side wall 723. The cover 6 is an arm cover.

In the vehicle 100 according to the first variation, since each arm 72 includes the side wall 723 between the cables 3 and the coilover 75, the side wall 723 can prevent interference between the cables 3 and the coilover 75.

Since the cables 3 are brake hoses, the side wall 723 can prevent interference between the brake hoses and the coilover 75.

Since the side wall 723 is located along a portion of the periphery of the coilover 75, the side wall 723 can prevent interference between the cables 3 and the coilover 75.

Since the cover 6 covers the cables 3 from above and from the outer side in the vehicle width directions, the cover 6 can protect the cables 3 against stones and other substance that are thrown up from the wheels during traveling of the vehicle.

Since the cover 6 serves as the tunnel structure together with the side wall 723, the cover 6 covers the periphery of the cables 3.

Since the cover 6 is an arm cover, the arm cover also protects the cables 3.

The description of other configurations, operations, and effects will be omitted, but the description of the vehicle 100 according to the embodiment can be used for the description of the vehicle 100 according to the first variation.

### OTHER EMBODIMENTS

In the foregoing section, the embodiment has been described as an example of the technique disclosed in the present application. The technique disclosed here, however, is not limited to this embodiment, and is applicable to other embodiments obtained by changes, replacements, additions, and/or omissions as necessary. Components described in the above embodiment may be combined as a new exemplary embodiment. Components provided in the accompanying drawings and the detailed description can include components unnecessary for solving problems as well as components necessary for solving problems in order to exemplify the technique. Therefore, it should not be concluded that such unnecessary components are necessary only because these unnecessary components are included in the accompanying drawings or the detailed description.

The suspensions 7 are rear suspensions, and the stabilizer bar 8 is a rear stabilizer bar. Alternatively, the suspensions 7 may be front suspensions, and the stabilizer bar 8 may be a front stabilizer bar. In this case, the “one side in the front-rear directions” herein is forward. That is, the arms 72 extend forward from the body frame 2. The arm parts 82 of the stabilizer bar 8 extend forward from the bar body 81, and the front ends of the arm parts 82 are coupled to the link rods 83. The arm parts 82 extend upward toward the front. The arm parts 82 extend outward in the vehicle width directions toward the front in a plan view.

Although each of the arm parts 82 includes the first portion 82a and the second portion 82b, each arm part 82 may include a linear third portion extending rearward from the second portion 82b, in addition to the first portion 82a and the second portion 82b. Alternatively, each arm part 82 may extend linearly upward toward the rear. Alternatively, each arm part 82 may be curved to extend upward toward the rear. In this case, each arm part 82 may be curved to be convex downward or may be curved to be convex upward.

Although the first portion 82a is tilted less than the second portion 82b, the first portion 82a may be tilted greater than the second portion 82b.

Although the second portion 82b is located rearward of the beam frame 24, the second portion 82b may overlap the beam frame 24 in the top-bottom directions.

The beam frame 24 is an example of a “structure located above the arm parts 82” herein, but the structure may be, for example, an electric component. In this case, the second portion 82b is located rearward of the electric component.

The intermediate portion 823 of each arm part 82 is located below the imaginary line L1 when seen in the vehicle width directions, but may be located above the imaginary line L1.

The second end portion 822 of each arm part 82 is located above the imaginary tangent L2 when seen in the vehicle width directions, but may be located below the imaginary tangent L2.

The axis B1 of the bar body 81 is located below the seats 17, but may be located above the seats 17.

The distance between the axis B1 of the bar body 81 and the rotation axis A1 of each arm 72 is shorter than the length of the link rods 83, but may be longer than the length of the link rods 83.

The arm parts 82 extend along the arms 72 in a plan view, but may extend to intersect the arms 72 in a plan view.

The arm parts 82 extend outward in the vehicle width directions toward the rear in a plan view, but may extend inward in the vehicle width directions toward the rear in a plan view. The arms 72 extend outward in the vehicle width directions toward the rear in a plan view, but may extend inward in the vehicle width directions toward the rear in a plan view.

The cables 3 includes the first cable 31 and the second cable 32, but may include other cables. Alternatively, the cables 3 may include any one of the first cable 31 or the second cable 32.

The cover part 722 of each arm 72 includes the side wall 723, but the side wall 723 may be separated from the cover part 722. In this case, the cover part 722 may be omitted.

The cover 6 serves as the tunnel structure together with the side wall 723, but the cover 6 may be separated from the side wall 723.

The cover 6 is an arm cover, but may be a cover different from an arm cover.

The technique disclosed here is also applicable to an off-road vehicle other than the utility vehicle 100.

### Aspects

The embodiments described above are specific examples of the following aspects.

(Aspect 1)

An utility vehicle 100 (off-road vehicle) includes: a body frame 2; left and right arms 72 rotatably coupled to the body frame 2; a stabilizer bar 8 supported by the body frame 2 and extending above the left and right arms 72; and link rods 83 that couple both ends of the stabilizer bar 8 to the left and right arms 72, the stabilizer bar 8 includes a bar body 81 extending in vehicle width directions, and arm parts 82 individually extending from both ends of the bar body 81 toward one side in front-rear directions and coupled to the link rods 83, and the arm parts 82 extend upward toward the one side.

In this configuration, since the arm parts 82 extend upward toward the one side, end portions of the arm parts 82 on one side are separated from the arms 72 so that the length of the link rods 83 can be thereby increased. Accordingly, when the link rods 83 swing following upward swing of the arms 72, the swing angle of the link rods 83 can be reduced. This can reduce a load applied to coupling portions between the link rods 83 and the arm parts 82 and coupling portions between the link rods 83 and the arms 72. For example, in the case of using a ball joint in a coupling portion, since the ball joint has a limited swing angle but the link rods 83 have a small swing angle, a load applied to the ball joint can be reduced.

(Aspect 2)

In the utility vehicle 100 of Aspect 1, each of the arm parts 82 includes a linear first portion 82a extending from the bar body 81 toward the one side, and a linear second portion 82b extending from the first portion 82a toward the one side, and the first portion 82a is tilted less than the second portion 82b.

In this configuration, since the first portion 82a is tilted less than the second portion 82b, in a case where the body frame 2 includes the beam frame 24 located above the first portion 82a and extending in the vehicle width directions, even when the arm parts 82 swing upward following upward swing of the arms 72, contact between the arm parts 82 and the beam frame 24 can be avoided.

(Aspect 3)

In the utility vehicle 100 of Aspect 1 or 2, the second portion 82b is located closer to the one side than a structure located above the arm parts 82.

In this configuration, since the second portion 82b is located closer to the one side than the structure, even when the arm parts 82 swing upward following upward swing of the arms 72, contact between the arm parts 82 and the structure can be avoided.

(Aspect 4)

In the utility vehicle 100 of any one of Aspects 1 to 3, the structure is a beam frame 24 extending in the vehicle width directions in the body frame 2.

In this configuration, since the structure is the beam frame 24, even when the arm parts 82 swings upward following upward swing of the arms 72, contact between the arm parts 82 and the beam frame 24 can be avoided.

(Aspect 5)

In the utility vehicle 100 of any one of Aspects 1 to 4, an intermediate portion 823 of each of the arm parts 82 is separated from an imaginary line L1 coupling both end portions 821 and 822 of the arm part 82, when seen in the vehicle width directions.

In this configuration, each of the arm parts 82 is not in a straight line, and thus, the arm parts 82 can be easily disposed to avoid interference with a surrounding structure.

(Aspect 6)

In the utility vehicle 100 of any one of Aspects 1 to 5, both end portions 821 and 822 of each of the arm parts 82 include a first end portion 821 connected to the bar body 81, and a second end portion 822 connected to a corresponding one of the link rods 83, and the second end portion 822 is separated from an imaginary tangent L2 that is in contact with a lower end of the first end portion 821 and extends toward the one side, when seen in the vehicle width directions.

In this configuration, each of the arm parts 82 is not in a straight line, and thus, the arm parts 82 can be easily disposed to avoid interference with a surrounding structure.

(Aspect 7)

In the utility vehicle 100 of any one of Aspects 1 to 6, the arm parts 82 extend along the arms 72 in a plan view.

In this configuration, since the arm parts 82 extend along the arms 72 in a plan view, when the link rods 83 swing following upward swing of the arms 72, the swing angle of the link rods 83 can be reduced.

(Aspect 8)

In the utility vehicle 100 of any one of Aspects 1 to 7, each of the arm parts 82 extends outward in the vehicle width directions toward the one side in a plan view.

In this configuration, since each of the arm parts 82 extends outward in the vehicle width directions toward the one side in a plan view, in a case where the arms 72 extend outward in the vehicle width directions toward the one side in a plan view, the arm parts 82 extend along the arms 72. Accordingly, when the link rods 83 swing following upward swing of the arms 72, the swing angle of the link rods 83 can be reduced.

(Aspect 9)

The utility vehicle 100 of any one of Aspects 1 to 8 further includes a seat 17 supported by the body frame 2, the bar body 81 is supported by the body frame 2 to be rotatable about an axis B1 of the bar body 81, and the axis B1 of the bar body 81 is located below the seat 17.

In this configuration, since the axis B1 of the bar body 81 is located below the seat 17, the axis B1 of the bar body 81 can be made closer to a coupling portion between the arms 72 and the body frame 2. Accordingly, the angle formed by the stabilizer bar 8 and each link rod 83 can be made close to 90°, and when the arms 72 swing upward, the link rods 83 transfer an upward force applied to the arms 72 to the arm parts 82 without releasing the force in other directions. This can reduce a load applied to the link rods 83.

(Aspect 10)

In the utility vehicle 100 of any one of Aspects 1 to 9, the bar body 81 is supported by the body frame 2 to be rotatable about an axis B1 of the bar body 81, the arms 72 are coupled to the body frame 2 to be rotatable about a rotation axis A1 extending in the vehicle width directions, and a distance between the axis B1 of the bar body 81 and the rotation axis A1 of each of the arms 72 is shorter than a length of each of the link rods 83.

In this configuration, since the distance between the axis B1 of the bar body 81 and the rotation axis A1 of each arm 72 is shorter than the length of the link rods 83, the axis B1 of the bar body 81 can be made closer to the rotation axis A1 of the arm 72. Accordingly, the angle formed by the stabilizer bar 8 and each link rod 83 can be made close to 90°, and when the arms 72 swing upward, the link rods 83 transfer an upward force applied to the arms 72 to the arm parts 82 without releasing the force in other directions. This can reduce a load applied to the link rods 83.

(Aspect 11)

In the utility vehicle 100 of any one of Aspects 1 to 10, the arm parts 82 are located outward of the arms 72 in the vehicle width directions.

In this configuration, since the arm parts 82 are located outward of the arms 72 in the vehicle width directions, interference of the arm parts 82 with the arms 72 can be reduced.

(Aspect 12)

The utility vehicle 100 of any one of Aspects 1 to 11 further includes a coilover 75 located inward of each of the arms 72 in the vehicle width directions, and each of the arms 72 includes an arm body 721 in which a cable 3 is located, and a side wall 723 attached to the arm body 721 and located between the cable 3 and the coilover 75.

In this configuration, since each of the arms 72 includes the side wall 723 between the cable 3 and the coilover 75, the side wall 723 can avoid interference between the cable 3 and the coilover 75.

(Aspect 13)

A utility vehicle 100 (off-road vehicle) includes: a body frame 2; left and right arms 72 rotatably coupled to the body frame 2; and a coilover 75 located inward of each of the arms 72 in vehicle width directions, and each of the arms 72 includes an arm body 721 in which a cable 3 is located, and a side wall 723 attached to the arm body 721 and located between the cable 3 and the coilover 75.

In this configuration, since each of the arms 72 includes the side wall 723 between the cable 3 and the coilover 75, the side wall 723 can avoid interference between the cable 3 and the coilover 75.

(Aspect 14)

In the utility vehicle 100 of Aspect 13, the cable 3 is a brake hose.

In this configuration, since the cable 3 is a brake hose, the side wall 723 can avoid interference between the brake hose and the coilover 75.

(Aspect 15)

In the utility vehicle 100 of Aspect 13 or 14, the side wall 723 is located along a portion of a periphery of the coilover 75.

In this configuration, since the side wall 723 is located along a portion of the periphery of the coilover 75, the side wall 723 can avoid interference between the cable 3 and the coilover 75.

(Aspect 16)

The utility vehicle 100 of any one of Aspects 13 to 15 further includes a cover 6 covering the cable 3 from above and from an outer side in the vehicle width directions.

In this configuration, since the cover 6 covers the cable 3 from above and from the outer side in the vehicle width directions, the cover 6 can protect the cable 3 against stones and other substance that are thrown up from the wheels during traveling of the vehicle.

(Aspect 17) In the utility vehicle 100 of any one of Aspects 13 to 16, the cover 6 serves as a tunnel structure through which the cable 3 passes, together with the side wall 723.

In this configuration, since the cover 6 serves as the tunnel structure together with the side wall 723, the cover 6 can cover the periphery of the cable 3.

(Aspect 18)

In the utility vehicle 100 of any one of Aspects 13 to 17, the cover 6 is an arm cover.

In this configuration, since the cover 6 is an arm cover, the arm cover also protects the cable 3.

What is claimed is:

1. An off-road vehicle comprising:
a body frame;
left and right arms rotatably coupled to the body frame;
a stabilizer bar supported by the body frame and extending above the left and right arms; and
link rods that couple both ends of the stabilizer bar to the left and right arms, wherein
the stabilizer bar includes a bar body extending in vehicle width directions, and arm parts individually extending from both ends of the bar body toward one side in front-rear directions and coupled to the link rods, and
the arm parts extend upward toward the one side.

2. The off-road vehicle according to claim 1, wherein
each of the arm parts includes a linear first portion extending from the bar body toward the one side, and a linear second portion extending from the first portion toward the one side, and
the first portion is tilted less than the second portion.

3. The off-road vehicle according to claim 2, wherein
the second portion is located closer to the one side than a structure located above the arm parts.

4. The off-road vehicle according to claim 3, wherein
the structure is a beam frame extending in the vehicle width directions in the body frame.

5. The off-road vehicle according to claim 1, wherein
an intermediate portion of each of the arm parts is separated from an imaginary line coupling both end portions of the arm part, when seen in the vehicle width directions,

6. The off-road vehicle according to claim 1, wherein
both end portions of each of the arm parts include a first end portion connected to the bar body, and a second end portion coupled to a corresponding one of the link rods, and
the second end portion is separated from an imaginary tangent that is in contact with a lower end of the first end portion and extends toward the one side, when seen in the vehicle width directions.

7. The off-road vehicle according to claim 1, wherein
the arm parts extend along the arms in a plan view.

8. The off-road vehicle according to claim 1, wherein
each of the arm parts extends outward in the vehicle width directions toward the one side in a plan view.

9. The off-road vehicle according to claim 1, further comprising
a seat supported by the body frame, wherein
the bar body is supported by the body frame to be rotatable about an axis of the bar body, and
the axis of the bar body is located below the seat.

10. The off-road vehicle according to claim 1, wherein
the bar body is supported by the body frame to be rotatable about an axis of the bar body,
the arms are coupled to the body frame to be rotatable about a rotation axis extending in the vehicle width directions, and
a distance between the axis of the bar body and the rotation axis of each of the arms is shorter than a length of each of the link rods.

11. The off-road vehicle according to claim 1, wherein
the arm parts are located outward of the arms in the vehicle width directions.

12. The off-road vehicle according to claim 1, further comprising
a coilover located inward of each of the arms in the vehicle width directions, wherein
each of the arms includes an arm body in which a cable is located, and a side wall attached to the arm body and located between the cable and the coilover.

13. An off-road vehicle comprising:
a body frame; and
left and right arms rotatably coupled to the body frame; and
a coilover located inward of each of the arms in vehicle width directions, wherein
each of the arms includes an arm body in which a cable is located, and a side wall attached to the arm body and located between the cable and the coilover.

14. The off-road vehicle according to claim 13, wherein
the cable is a brake hose.

15. The off-road vehicle according to claim 13, wherein
the side wall is located along a portion of a periphery of the coilover.

16. The off-road vehicle according to claim 13, further comprising
a cover covering the cable from above and from an outer side in the vehicle width directions.

17. The off-road vehicle according to claim 16, wherein
the cover serves as a tunnel structure through which the cable passes, together with the side wall.

18. The off-road vehicle according to claim 16, wherein
the cover is an arm cover.
